(19) United States
(12) Patent Application Publication
(10) Pub. No.: US 2013/0138438 A1
(43) Pub. Date: May 30, 2013

(54) SYSTEMS AND METHODS FOR CAPTURING, PUBLISHING, AND UTILIZING METADATA THAT ARE ASSOCIATED WITH MEDIA FILES

(71) Applicants: Walter Bachtiger, Novato, CA (US); Jan Jannink, Menlo Park, CA (US); Spencer Lord, San Francisco, CA (US)

(72) Inventors: Walter Bachtiger, Novato, CA (US); Jan Jannink, Menlo Park, CA (US); Spencer Lord, San Francisco, CA (US)

(21) Appl. No.: 13/751,112

(22) Filed: Jan. 27, 2013

Related U.S. Application Data
(63) Continuation-in-part of application No. 13/271,195, filed on Oct. 11, 2011.
Application No. 13/271,195 is a continuation-in-part of application No. 12/878,014, filed on Sep. 8, 2010.
(60) Provisional application No. 61/591,890, filed on Jan. 28, 2012.
(60) Provisional application No. 61/244,096, filed on Sep. 21, 2009.

(51) Int. Cl. G10L 15/26

(52) U.S. Cl. CPC G10L 15/26
USPC 704/235

(57) ABSTRACT

Systems for recording, searching for, and obtaining metadata that are relevant to a plurality of media files are disclosed. The systems generally include a server that is configured to receive, index, and store a plurality of media files, which are received by the server from a plurality of sources, within at least one database in communication with the server. In addition, the server is configured to make one or more of the media files accessible to and searchable by, one or more persons—other than the original sources of such media files. Still further, the server is configured to display metadata that are associated with each media file. Such metadata may include links to one or more profile pages that are published within one or more social networks, with each of such profile pages being correlated with a unique voice signature that is detected within each media file. In addition, these metadata may include a geographical area from which each media file is provided to the server; a date on which each media file was created; a popularity index that is assigned to each media file; one or more theme categories that are assigned to each media file; or combinations of the above.

### CROSS-REFERENCE TO RELATED APPLICATIONS

This application is a non-provisional application of, and claims priority to, U.S. provisional application Ser. No. 61/591,890, filed on Jan. 28, 2012, and is also a continuation-in-part of U.S. patent application Ser. No. 13/271,195, filed on Oct. 11, 2011, which is a continuation-in-part of U.S. patent application Ser. No. 12/878,014, filed on Sep. 8, 2010, which claims priority to U.S. provisional patent application Ser. No. 61/244,096, filed on Sep. 21, 2009.

### FIELD OF THE INVENTION

The field of the present invention relates to systems and methods for recording, indexing, and searching various types of media files and the audio tracks included therein and, more particularly, to systems and methods for capturing and utilizing metadata that are associated with a plurality of media files that are provided to the systems described herein.

### BACKGROUND OF THE INVENTION

Systems for recording and storing media files have been available for many years and, indeed, are used by many individuals and businesses today. In addition, currently-available systems allow users to retrieve, either using a telephone or internet connection, media files that may be stored in a database and correlated with a specific user of the system. Although these systems have become a ubiquitous part of communication (and communication management) in today's world, these systems do not efficiently capture, utilize, and make available to others, the value of the metadata that may be derived from, or are otherwise associated with, such media files.

For example, currently-available systems do not efficiently recognize voice signatures within the audio track of a media file, correlate such voice signatures with the identity of the corresponding speakers, and then make information that is external to the system, which is relevant or related to each of the corresponding speakers, available for review by the user of the system. Similarly, currently-available systems do not efficiently allow users to view information and statistics regarding media files, and/or third party commentary regarding the same, such as the dates of media file creation, the dates that media files were provided to the system, the time period of user activity for a media file, the number of playbacks associated with each media file, the number of times that each media file has been referred or shared among individuals, and the amount of external commentary associated with a particular media file. Still further, currently-available systems do not efficiently categorize media files into various themes or topics.

As described further below, the present invention addresses many of these, and other, drawbacks that are associated with currently-available media storage and retrieval systems.

### SUMMARY OF THE INVENTION

According to certain aspects of the present invention, systems are provided for searching, obtaining, and incorporating metadata associated with a plurality of media files. More particularly, the systems generally comprise a server that is configured to receive, index, and store a plurality of media files, which are received by the server from a plurality of sources, within at least one database in communication with the server. In addition, the invention provides that the server is configured to make one or more of the media files accessible to (and searchable by) one or more persons—other than the original sources of such media files. In other words, the media files that a first person records within the database of the system will be accessible and searchable by other persons. The invention further provides that upon the server receiving a key word (search term) that is submitted by a user of the system through a website, the server queries the database to identify all media files which include the key word. The system will then list such media files, which include the key word, in a set of search results.

In addition, the invention provides that the server is configured to display, in a graphical user interface of a website, various types of metadata that are associated with each media file. For example, such metadata may include links to one or more profile pages that are published within one or more social networks, with each of such profile pages being correlated with a unique voice signature that is detected within each media file. In addition, these metadata may identify a geographical area from which each media file is provided to the server, with such geographical area data being provided to the server by a global positioning system or internet protocol address, at the time when the media file is provided to the server.

Additional examples of metadata that the system will obtain, and display to a user of the system, include a date on which each media file was created; a popularity index that is assigned to each media file; one or more theme categories that are assigned to each media file; or combinations of the above. The invention provides that the popularity index may be based upon (i) a number of times that each media file has been played by users of the system; (ii) a number of times that each media file has been shared with or referred to others through the website; (iii) a total number of comments associated with each media file (which are viewable within the website); or (iv) combinations of such factors. The invention further provides that the one or more theme categories that are assigned to each media file will be based upon the presence and frequency of various terms within the audio content of each media file, with each of such various terms being correlated and catalogued within one or more theme categories.

The invention provides that the acquisition and publication of the types of metadata described above will render the media file storage and retrieval system described herein more useful, powerful, and intuitive. Such metadata will also efficiently convey the relevancy of media files to a user's interests, as well as the associations and connections that a particular media file may have to individual persons, geographic locations, and other relevant information.

The above-mentioned and additional features of the present invention are further illustrated in the Detailed Description contained herein.

### BRIEF DESCRIPTION OF THE FIGURES

FIG. 1 is a diagram showing the different components of the systems described herein.

FIG. 2 is a diagram showing the interactive nature and media file sharing capability of the systems described herein.

FIG. 3 is a flow chart illustrating the controls provided by the systems described herein, which allow only specified users to access certain media files and/or comments related thereto within the centralized website.

FIG. 4 is a diagram showing certain non-limiting components of an exemplary graphical user interface in which a user may query the content of a plurality of media files, identify those media files which include a certain key word (or set of key words) that the user defines, and quickly view the context in which such key word is used in one or more media files.

FIG. 5 is another diagram that illustrates the means by which the systems and methods described herein allow users to query a large body of media files, and then playback excerpted and relevant portions thereof using a media player.

FIG. 6 is a diagram that illustrates a graphical user interface of the system described herein, which exemplifies the system's ability to retrieve and publish a social network profile page for a speaker who is identified within a media file.

FIG. 7 is a diagram that illustrates a graphical user interface of the system described herein, which exemplifies the system's ability to retrieve and publish geographical source information regarding each media file.

FIG. 8 is a diagram that illustrates a graphical user interface of the system described herein, which exemplifies the system's ability to retrieve and publish a popularity index value for each media file, as described herein.

FIG. 9 is a diagram that illustrates a graphical user interface of the system described herein, which exemplifies the system's ability to retrieve and publish a theme category (or categories) that has been assigned to each media file.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

Description of the Media File Storage and Retrieval Systems

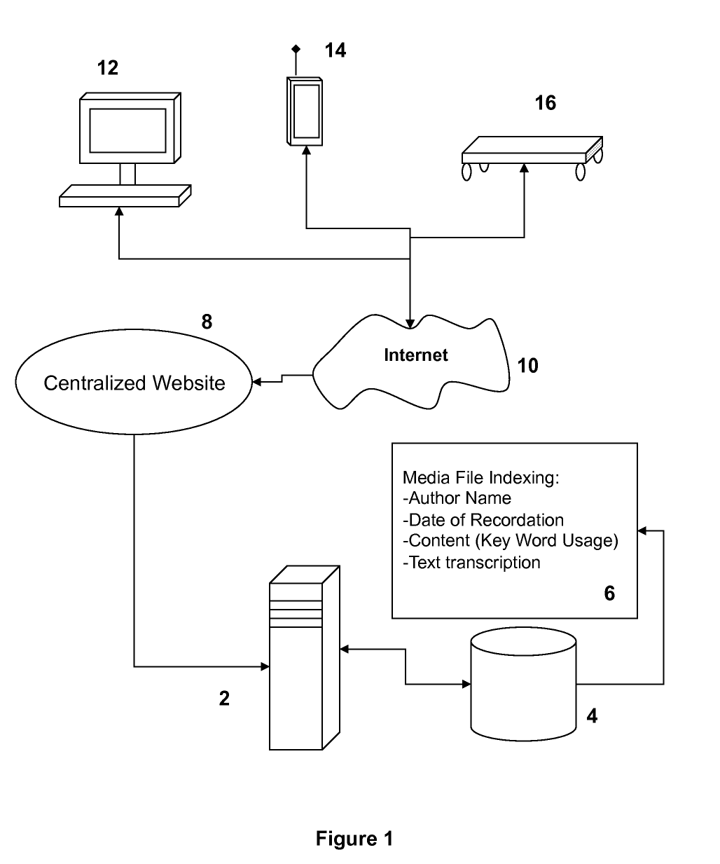

According to certain preferred embodiments, the present invention generally utilizes systems for recording, indexing, transcribing, and sharing media files among a plurality of users. As used herein, the term “media file(s)” refers to audio files, video files, voice recordings, streamed media content, and combinations of the foregoing. Referring to FIG. 1, the systems generally comprise a server 2 that is configured to receive, index, and store a plurality of media files, which are received by the server 2 from a plurality of sources, within at least one database 4 in communication with the server 2. The invention provides that the database 4 may reside within the server 2 or, alternatively, may exist outside of the server 4 while being in communication therewith via a network connection.

When the present specification refers to the server 2, the invention provides that the server 2 may comprise a single server or a group of servers. In addition, the invention provides that the system may employ the use of cloud computing, whereby the server paradigm that is utilized to support the system of the present invention is scalable and may involve the use of different servers (and a variable number of servers) at any given time, depending on the number of individuals who are utilizing the system at different time points, which are in fluid communication with the database 4 described herein.

The media files may be indexed 6 and categorized within the database 4 based on author, time of recordation, geographical location of origin, IP addresses, language, key word usage, combinations of the foregoing, and other factors. The invention provides that the media files are preferably submitted to the server 2 through a centralized website 8 that may be accessed through a standard internet connection 10. The invention provides that the website 8 may be accessed, and the media files submitted to the server 2, using any device that is capable of establishing an internet connection 10, such as using a personal computer 12 (including tablet computers), telephone 14 (including smart phones, PDAs, and other similar devices), meeting conference speaker phones 16, and other devices. The invention provides that the media files may be created by such devices and then uploaded to the server 2 or, alternatively, the media files may be streamed in real time (through such devices) with the media files being created (and then indexed and stored) within the server 2 and database 4. In addition, as explained above, the invention provides that the media files that are stored within the server 2 and database 4 may be derived from audio-only content (e.g., a telephone conversation or talk radio) or, in certain cases, may comprise audio tracks derived from a video file (which has an audio component embedded therein).

The invention provides that the server 2 may receive and manage media files in many ways, such that the contents thereof may be deciphered and used as described herein. For example, the invention provides that upon a media file being submitted to the server 2, the server 2 will perform a speech-to-text, speech-to-phoneme, speech-to-syllable, and/or speech-to-subword conversion, and then store an output of such conversion within the database 4. This way, the content of each media file may be intelligently queried and used in the manner described herein, such as for querying such content for key words.

The invention provides that when reference is made to “media files that contain a key word,” and similar phrases, it should be understood that such phrase encompasses a text file that contains the key word, with the text file being derived from a media file, as explained above. In other words, for example, after performing a speech-to-text conversion, and storing such text within the database 4, if a search is performed using the system of the present invention for media files that contain a particular key word, the system will actually search the converted text forms of such media files. Upon identifying any text forms of such media files that contain the queried key word, it will be inferred that the media file that corresponds with the searched text file will actually contain the key word.

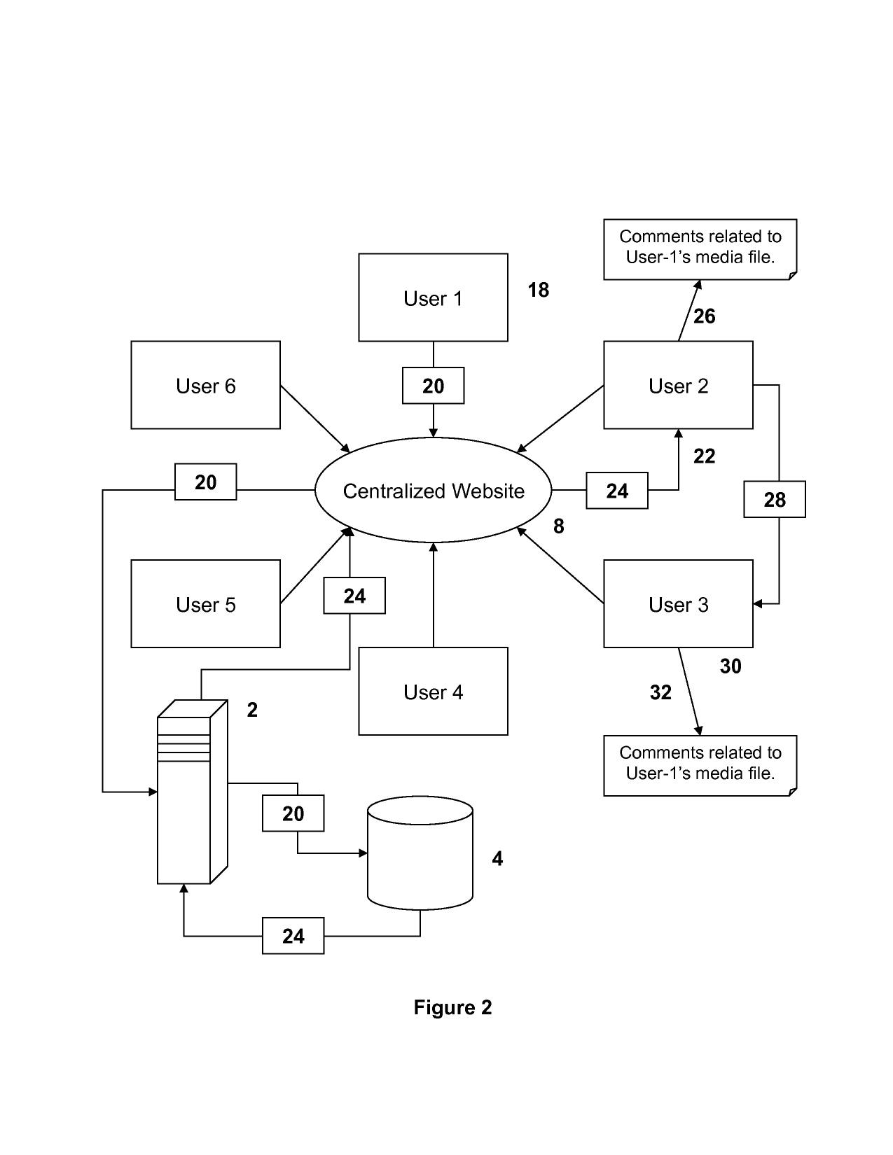

Referring now to FIG. 2, according to certain preferred embodiments, the invention provides that the server 2 is configured to make one or more of the media files accessible to persons other than the original source (or author) of the media files. The invention provides that the term “source” refers to a person who is responsible for uploading a media file to the server 2, whereas the term “author” refers to one or more persons who contributed content to an uploaded media file (who may, or may not, be the same person who uploads the media file to the server 2). For example, as illustrated in FIG. 2, a first user (User-1) 18 may submit 20 a media file to the server 2 through the centralized website 8, which is then indexed and stored within a database 4. The invention provides that if certain conditions are satisfied, as described below, the media files that the first user (User-1) 18 records within and uploads to the database 4 will then be accessible by other persons. For example, a second user (User-2) 22 may retrieve 24 and listen to User-1's media file from the database 4 through the centralized website 8.

Upon retrieving and accessing User-1's media file, User-2 22 may publish comments 26 regarding User-1's media files within a graphical user interface of the website 8. Moreover, User-2 22 may publish comments 26 regarding certain limited portions of User-1's media files, with the relative location of such comments being quickly ascertainable within the graphical user interface of the website 8. The invention provides that the comments 26 may be submitted to the server 2 through the website 8 by User-2 22, or any other persons who are granted access to User-1's 18 original media files. The invention provides that the comments 26 will be associated with User-1's 18 original media files within the database 4, along with other information collected by the server 2, such as the identity of the user/person submitting the comments 26, the date and time of submission, and/or other relevant information.

The invention further provides that the comments 26 may be viewed by any person accessing the website 8 or, alternatively, a limited group of persons who are granted access to User-1's 18 original media files. For example, an author of a media file, and/or the person (source) who submits a media file to the server 2, may submit instructions to the server 2 which only allow certain persons to access and listen to the media file. The invention provides that such access controls may be employed if a user (or author or source of a media file) does not want a media file to be generally available to all users of the system.

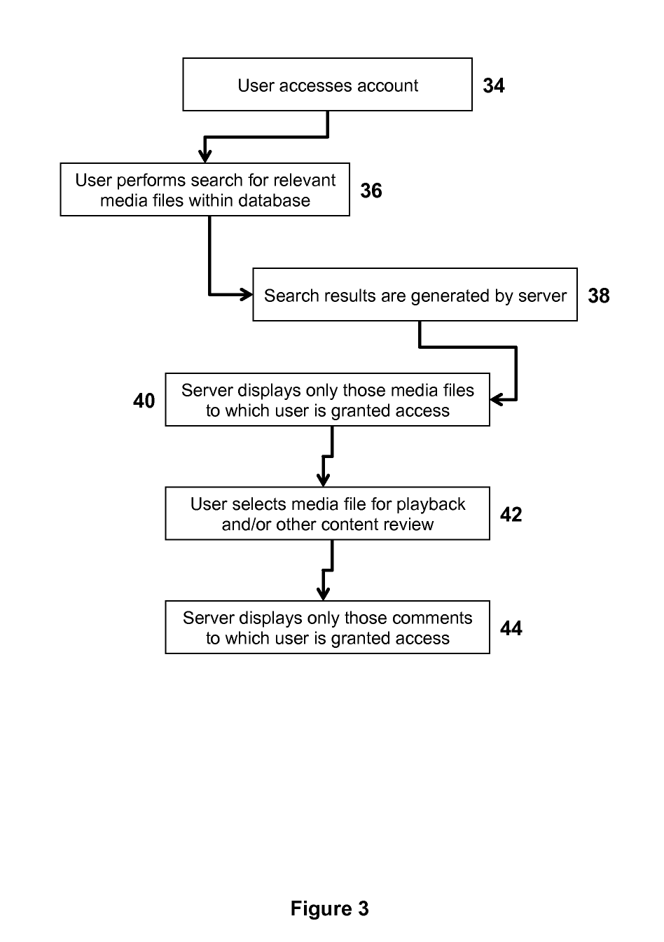

Referring to FIG. 3, for example, the invention provides that a user may access his/her account 34, by providing the server 2 with an authorized username/password through the centralized website 8. The user may then perform a search 36 of the database 4 for desired media files, namely, media files containing one or more search terms (key words), as described herein. The invention provides that the server 2 will then generate a list of results 38, i.e., media files that contain one or more of the queried search terms, and then display (within the centralized website 8) only those media files to which the user is granted access 40. The user may then select one or more media files within the viewable search results for playback and/or other content review 42. In addition, upon selecting a media file from the search results within the centralized website 8, the server 2 will display only those comments (related to the selected media file) that the user is allowed to view 44. In other words, the individuals who publish comments regarding a media file may further limit access to such comments to only authorized users of the system.

Referring now to FIG. 2, according to certain preferred embodiments, the invention provides that a user of the system, such as User-2 22, may refer 28 a media file (with or without comments 26 associated therewith) to another user. When the other user, e.g., User-3 30, receives notice of such referral 28, the other user may access and listen to the referred media file and, optionally, publish comments 32 regarding User-1's media files within a graphical user interface of the website 8. In addition, the invention provides that users of the system may share, refer, and transmit to other users a limited portion of one or more media files. For example, if a first user determines that a second user may find a particular portion of a media file to be of interest, the first user may refer only the interesting portion of that media file to the second user. According to such embodiments, the invention provides that the graphical user interface of the website 8 may include certain controls which allow a user to excise portions of a media file and refer the same to another user, e.g., by using time coordinates associated with a media file, from beginning to end, to identify and refer only the relevant portion of a media file to another user of the system. The act of referring a media file, or an excerpted version thereof, may be carried out by sending, e.g., by e-mail, a hyperlink to another individual (with the hyperlink being associated with and linked to a place in the database 4 from which the media file, or an excerpted version thereof, may be retrieved).

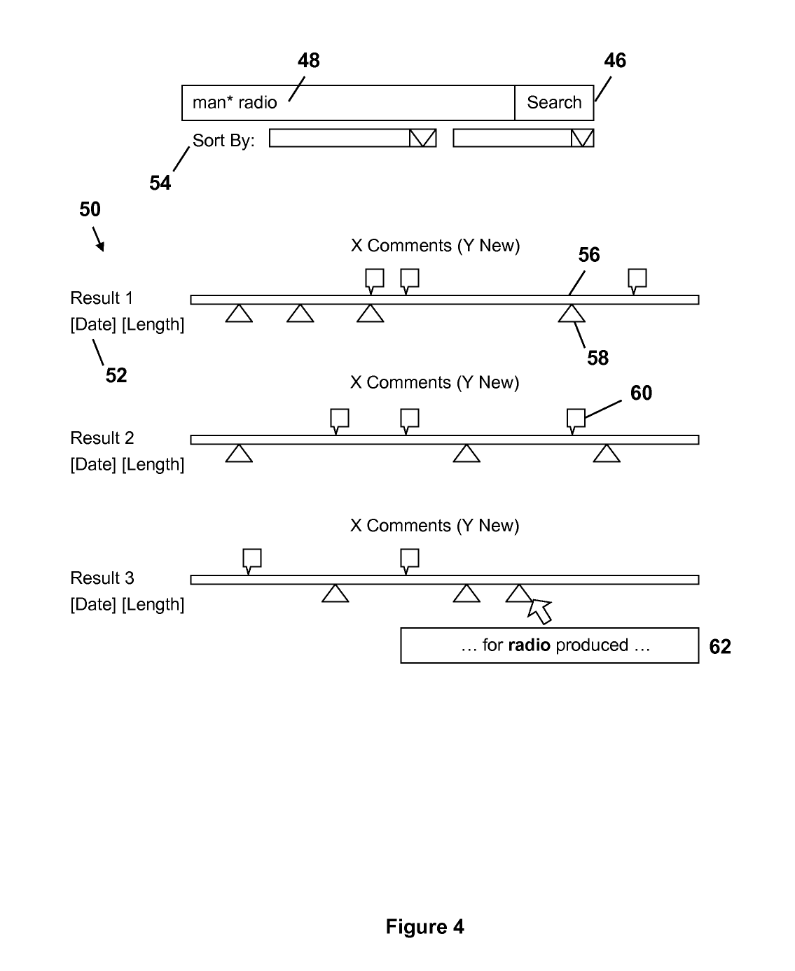

As mentioned above, according to certain preferred embodiments of the present invention, the system is configured to allow users to query the database 4, preferably through the website 8, for media files that include within the content thereof one or more key words. A non-limiting example of a portion of a graphical user interface showing an exemplary search function 46 is provided in FIG. 4. More particularly, the invention provides that the server 2 of the system may be configured to receive one or more key words 48 that are submitted by a user of the system through the website 8, whereupon the server 2 queries the database 4 to identify all media files which include the one or more key words 48. The invention provides that the system, and search function 46, may employ Boolean search logic, e.g., by allowing conjunctive and disjunctive searches, truncated and non-truncated forms of key words, exact match searches, and other forms of Boolean search logic.

The server 2 may then present the search results 50 to the user within the website 8 and, preferably, list all responsive media files in a defined order within such graphical user interface, but only those media files to which the user has been granted access, as described above. For example, the search results may list the media files in chronological order based on the date (and time) 52 that each media file was recorded and provided to the database 4. In other embodiments, the media files may be listed in an order that is based on the number of occasions that a key word is used within each media file. Still further, the media files may be listed based on the number of occurrences of key words in metadata associated with the media files, such as titles, description, comments, etc. In addition, the media files may be listed by measuring user activity, such as the number of views or plays, length of playing time, number of shares and comments, length of comments, etc. These criteria, combinations thereof, or other criteria may be employed to list the responsive media files in a manner that will be most relevant to the user. Still further, the invention provides that a user may specify the criteria that should be used to rank (and sort) the search results, with such criteria preferably being selected from a predefined list 54.

Still referring to FIG. 4, each media file included within a set of search results will preferably be graphically portrayed, such as in the form of a line 56 that begins at time equals zero (t=0) and ends at a point when the media file is terminated. For example, if the total length of a media file is five minutes, the left side of the line will be correlated with t=0 of the media file, whereas the right side of the line will be correlated with t=5 minutes of the media file. Still further, the invention provides that the location of each search term that was queried may be indicated along the line 56. For example, the location of each search term may be indicated with a triangle 58, or other suitable and readily visible element. The invention further provides that if multiple search terms were used in the search, the line 56 may be annotated with multiple triangles 58 (or other suitable elements), each of which may exhibit a different color that is correlated with a particular search term. More particularly, for example, if two search terms are used, the line 56 may be annotated with triangles 58 (or other suitable elements), which exhibit one of two colors, with one color representing a location of a first search term (key word) and a second color indicating the location of a second search term (key word).

The invention further provides that each line 56 that represents a relevant media file may be annotated with one or more comments 60 posted by other users, as described herein. The invention provides that such annotation of the comments 60 will preferably indicate the location within the media file to which each comment 60 relates. According to yet further embodiments, the invention provides that when a user places a cursor (within the graphical user interface of the centralized website 8) over or in the near vicinity of a triangle 58 (or other element indicating the location of a search term) or a comment 60, the graphical user interface of the website 8 will automatically publish a temporary text box 62 in which the search term may be viewed, along with a limited number of words before and after the search term (i.e., the context in which the search term is used), which were transcribed by the system from the media file.

The invention provides that the text box 62 (which contains the transcribed text) will allow a user to quickly review the context in which the search term is used, which will facilitate knowing whether the media file (or a portion thereof) may be relevant to the user and worthy of playback and/or further review. According to certain embodiments, the invention provides that a user may, optionally, control the number of words appearing before and after the search term in the text box 62, by entering the desired number of words in a specified field within the user's dedicated account page. This way, each user may adjust the size of the text box 62 in accordance with his/her personal preferences.

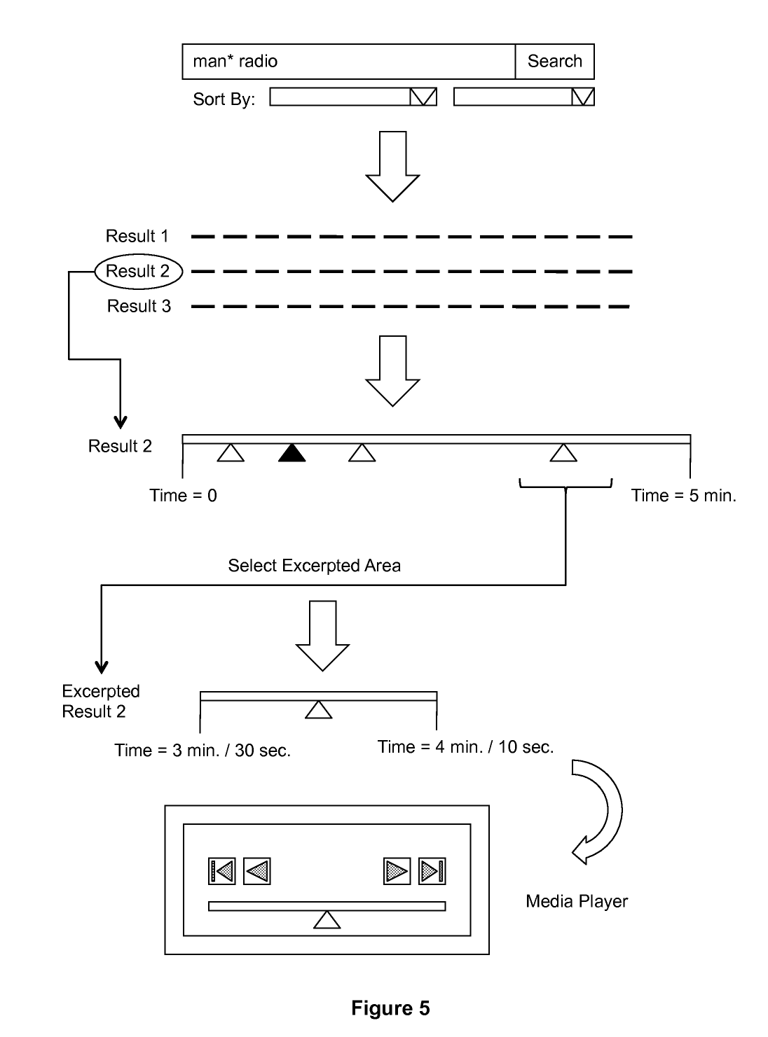

According to still further embodiments, the present invention provides that upon selecting a media file within the search results 50, the server will publish a portion of the transcribed text that surrounds the location of a key word. According to such embodiments, upon selecting the key word (or any other word included in the published text), the server 2 will cause a portion of the corresponding audio track (audio content) to be streamed to the user's device 12,14. Here again, the audio content may begin at the exact location at which the selected key word is found within the media file or, alternatively, at a predefined period of time prior to the location of the key word. As illustrated in FIG. 5, the invention provides that each media file that is selected and streamed to a user's device 12,14 may be graphically portrayed within the graphical user interface of the centralized website 8, which may further include a media player that allows a user to control the playback of the media file (or portion thereof).

Metadata Capture and Utilization Systems and Methods

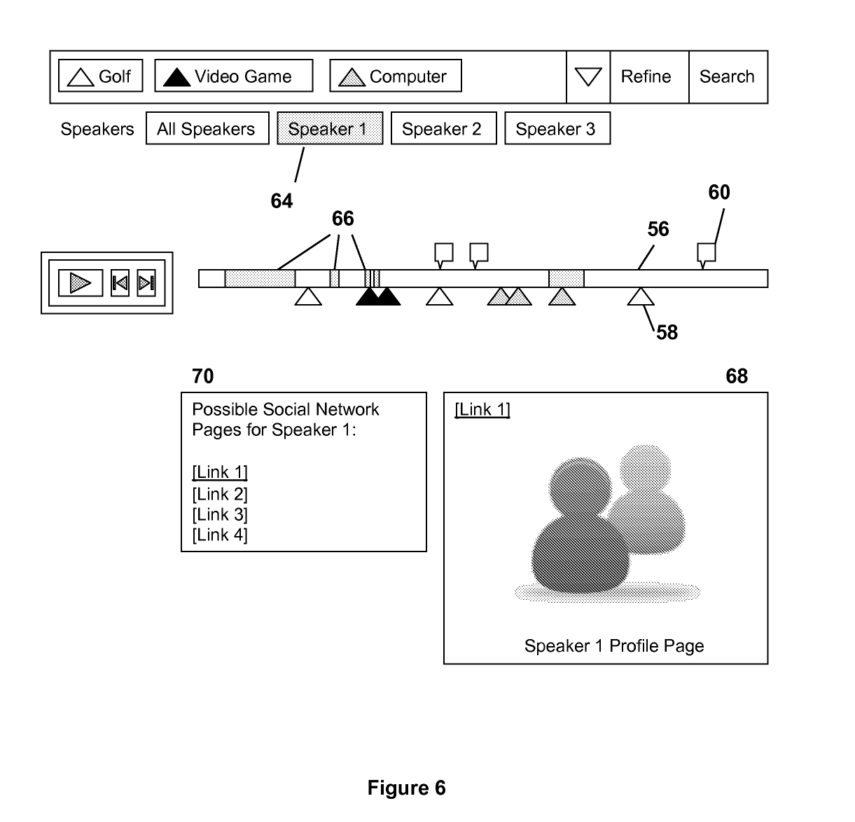

According to further embodiments of the present invention, systems and methods are provided for capturing and utilizing metadata that are associated with a plurality of media files that are provided to the systems described herein. According to certain preferred embodiments, in a first example, the invention provides that the server 2 may be configured to monitor and detect voice signatures that may be correlated with each speaker who contributes audio content to a plurality of media files stored within the database 4. The invention provides that the server 2 may correlate each unique voice signature with a specific speaker, and record such correlation in the database 4. The system may further be configured to assign an identity to each speaker, either based on a person's name that is referenced within the audio content of the media file or by manual input from a user of the system. Accordingly, and as illustrated in FIG. 6, the timeline 56 that represents a particular media file may visually annotate 66 those portions of the audio content that each identifiable speaker 64 contributed.

In addition, according to certain embodiments, the system may be configured to identify sources of information and data (external to the system) that are relevant to a particular speaker who has contributed content to a media file. For example, and referring to FIG. 6, upon identifying the voice signature that applies to a particular speaker who is contributing content in a particular media file, the server 2 will conduct an automatic query of one or more social networks, in search for a profile page 68 that may be relevant to such speaker. Once the server 2 identifies a potentially relevant profile page 68 for such speaker, the server 2 may publish the profile page 68, or a portion or summary thereof, within the graphical user interface of the website 8. Once the server 2 establishes a connection between a particular speaker (based on his/her voice signature) and one or more social network profile pages 68, the server 2 may record the location of and links to such pages within the database 4 for future retrieval—when, and if, the speaker's voice signature is detected in other media files in the future. The links 70 to such one or more social network profile pages 68 may also be published within the website 8.

Still further, the invention provides that the server 2 may establish such connections with external profile pages 68 for persons who are verbally identified within the content of a media file. For example, if a first person 64 is verbally identified (or verbally identifies a second person) within the content of a media file, the server 2 may search for and publish a profile page 68, or a portion or summary thereof, within the graphical user interface of the website 8, which relates to such verbally identified person. The invention provides that when searching a plurality of social network sites for profile pages 68 that are relevant to a particular media file, such queries may also take into account the geographical metadata (discussed below) that are also obtained for the particular media file.

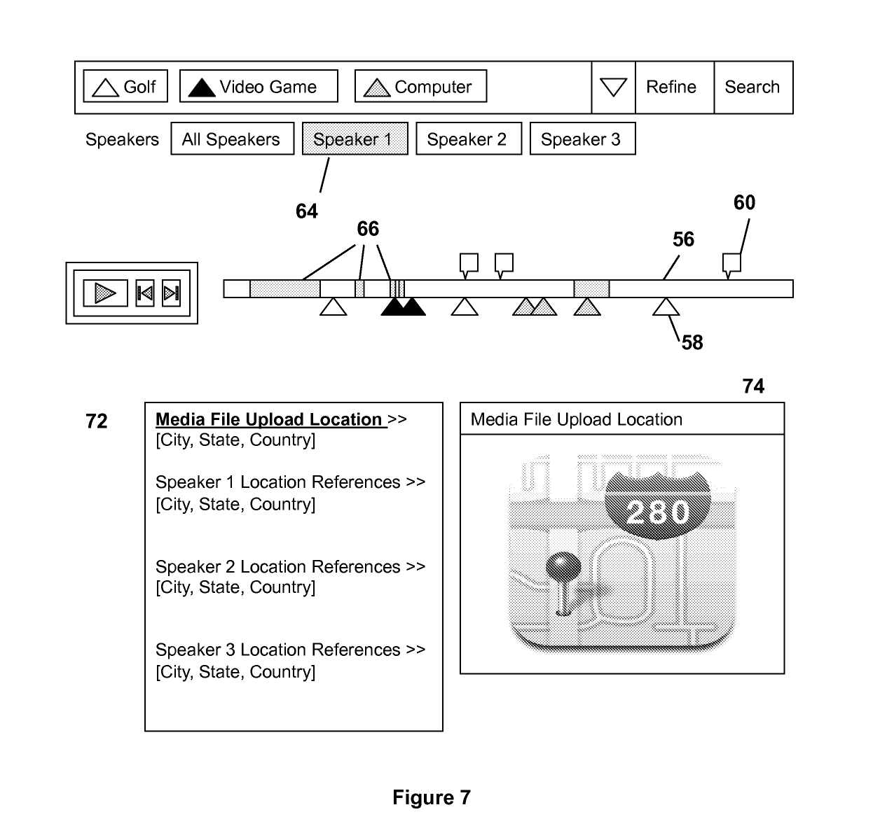

Referring now to FIG. 7, according to additional embodiments, the invention provides that the server 2 may be configured to identify and correlate a media file, and/or related comments 26, to a particular geographical area. More specifically, the invention provides that when a media file is created by (or through) a mobile phone device 14, which is equipped with a global positioning system (GPS), when such media file is uploaded to the server 2 through the website 8, the server 2 will detect and record the geographical location from which the media file is being uploaded to the server 2/database 4. As such, when the media file is later selected from a set of search results 50 by a user of the system, the website 8 will display the geographical location 72 from which the media file was uploaded to the system. Similarly, the invention provides that when a personal computer 12 (including tablet computers) is used to upload a media file to the server 2 through the website 8, the server 2 may, if certain conditions are satisfied, detect and record the geographical location of such personal computer 12 vis-à-vis the internet protocol address.

In related embodiments, the server 2 may be configured to detect the presence of spoken words that are contained in a media file. More particularly, the invention provides that the system may communicate to a user that, within the content of a particular media file, a speaker made one or more references to a particular geographical location, which may take the form of cities, states, countries, or specific places of business, recreation, entertainment, etc. In such embodiments, upon the server 2 detecting such content within a media file, when the media file is later selected from a set of search results 50 by a user of the system, the website 8 will display the geographical location (or places) that are referenced in the media file. In this embodiment, and the GPS-related embodiment described above, the website 8 may further display a map 74 of such geographical location 72, with such map 74 being streamed into the website 8 from a third party source.

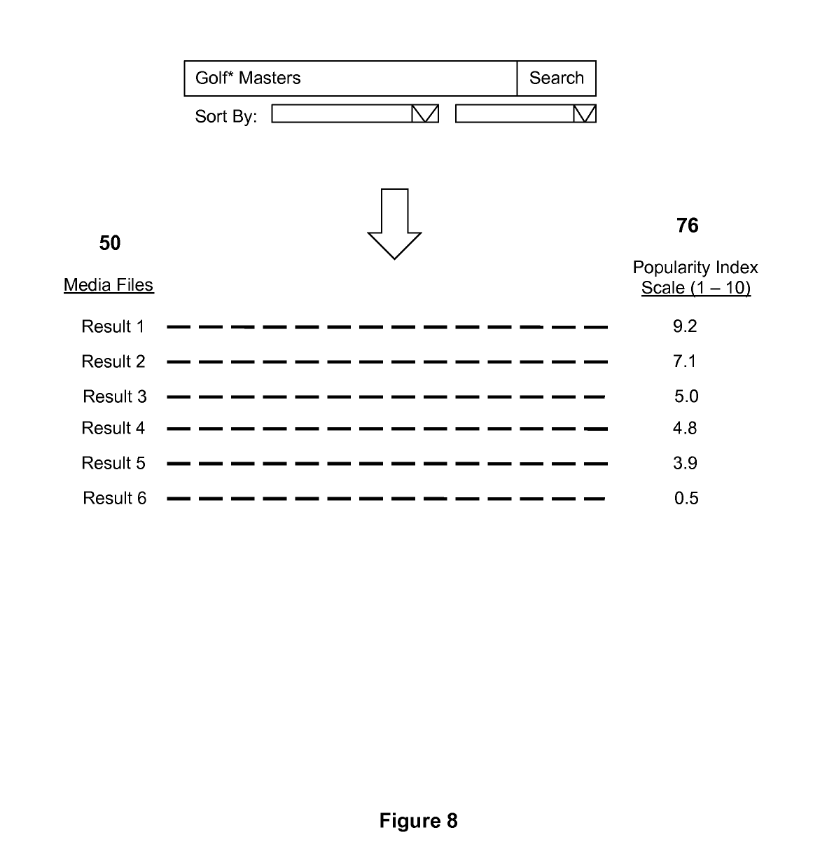

Still further, the invention provides that the website 8 may further display the date of media file creation. This type of metadata is highly relevant to, and useful for, an operator of the system, insofar as a user may want to know approximately how old (or new) the information contained in a media file should be. In addition, referring to FIG. 8, the website 8 may further display metadata that comprise user activity statistics, which will be relevant to the popularity of a particular media file (i.e., a popularity index 76), such as the number of times that a particular media file has been played by users at large, the number of times that a media file has been shared with (or referred 28 to) others, and the total number of comments 26 associated with each media file. Such metadata, along with the date of file creation, may influence a search algorithm and its ranking of media files in a set of search results 50. For example, the invention contemplates that a search algorithm may rank the media files, in a set of search results 50, in a way that is biased towards media files that are relatively recent in creation, media files that are more popular (based on the metrics listed above), or some combination of such criteria.

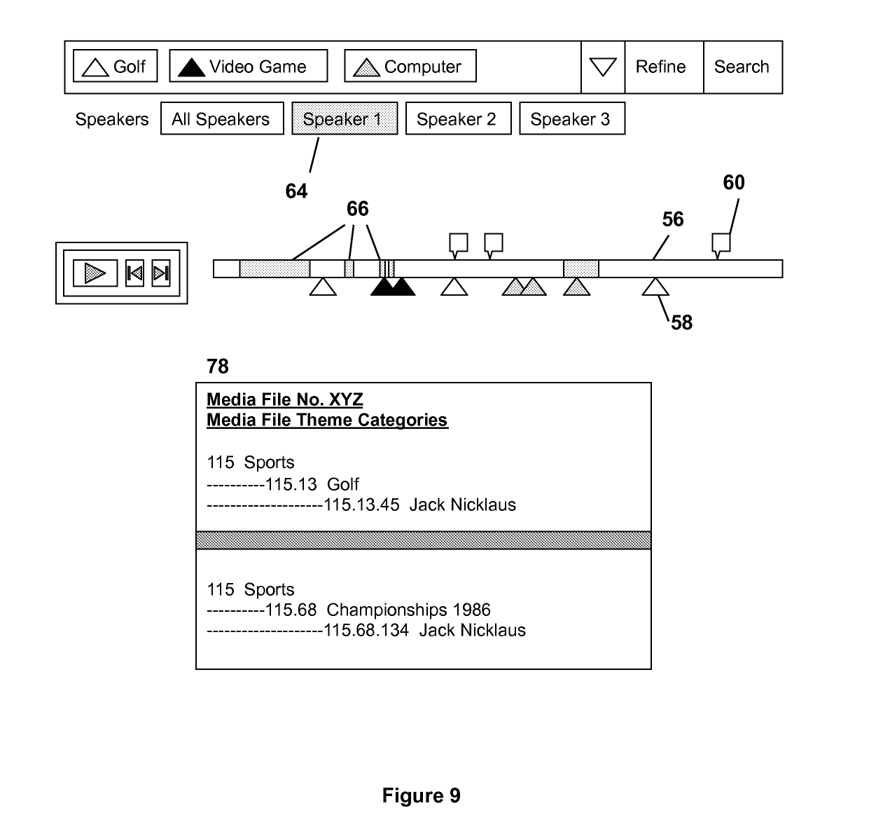

Referring now to FIG. 9, according to yet additional embodiments, the invention provides that the server 2 may be configured to monitor and detect key words within the content of each media file and, based on presence and frequency of those key words, categorize each media file into one or more different topic or theme categories 78. More specifically, for example, the database 4 of the system may include a plurality of different themes (or topic categories) 78, with various terms assigned to each theme. The server 2 may be configured to detect the presence, and frequency, of these various terms within the content of media files that are uploaded to the system. Moreover, the invention provides that hypernym/hyponym relationships may also be catalogued and used to identify the appropriate theme category (or categories) 78 that should be assigned to each media file.

According to these embodiments, a user of the system could browse a catalogue of various themes, and select a desired media file (or multiple media files) for playback and review. This would enable users to quickly identify those media files that are most likely to contain information that the user is seeking. Still further, the invention provides that the media file search functionalities described above could be focused within a particular theme (or group of themes), e.g., a search of all media files, which have been catalogued under a “sports” theme, for all media files that include the key word “golf.” In addition to top level theme identifiers, the invention provides that sub-themes, sub-sub-themes, and so on may be used to categorize and identify the content of media files. Furthermore, if a particular media file contains key words that span across multiple themes, the media file may be categorized under such multiple themes 78. The invention further provides that upon conducting a generalized search for all media files that contain a particular key word, as described above, the website 8 may publish a set of search results 50 as described above, as well as the theme category (or categories) that have been assigned to each media file within the set of search results 50.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for searching, and accessing metadata associated with, a plurality of media files, which comprises a server that is configured to:
(a) receive, index, and store the plurality of media files, which are received by the server from a plurality of sources, within at least one database in communication with the server;
(b) perform a text transcription of audio content included within the media files and store said transcription in the database; and
(c) obtain metadata associated with each media file and store said metadata within the database, wherein said metadata comprises: (i) links to one or more profile pages that are published within one or more social networks, wherein each of such profile pages are correlated with a unique voice signature that is detected within each media file; (ii) a geographical area from which each media file is provided to the server;
(iii) a date on which each media file was created; (iv) a popularity index that is assigned to each media file; (v) one or more theme categories that are assigned to each media file; or (vi) combinations of (i)-(v).

2. The system of claim 1, wherein the server is further configured to receive a key word that is submitted by a user of the system through a website, whereupon the server queries the database to identify all media files which include the key word, and then list such media files which include the key word in the website in a set of search results.

3. The system of claim 2, wherein upon selecting a media file from within the set of search results, the website will display the profile pages, or portions thereof or links thereto, which are correlated with each unique voice signature that is detected within the selected media file.

4. The system of claim 2, wherein upon selecting a media file from within the set of search results, the website will display the geographical area from which the media file was provided to the server.

5. The system of claim 4, wherein the geographical area from which the media file was provided to the server was identified by the server based on data provided by a global positioning system or internet protocol address, at a time when the media file was provided to the server.

6. The system of claim 2, wherein upon selecting a media file from within the set of search results, the website will display a date on which the media file was created.

7. The system of claim 2, wherein the popularity index that is assigned to each media file is based on: (a) a number of times that each media file has been played by users of the system; (b) a number of times that each media file has been shared with or referred to others through the website; (c) a total number of comments associated with each media file, which are viewable within the website; or (d) combinations of (a)-(c).

8. The system of claim 7, wherein (a) the date on which each media file was created and (b) the popularity index of each media file influence a ranking of the media files included in the set of search results.

9. The system of claim 2, wherein the database further comprises a table of theme categories, with each theme category being correlated with one or more terms.

10. The system of claim 9, wherein the server assigns one or more theme categories to each media file based on the presence and frequency of said one or more terms within the text transcription of the audio content of each media file.

11. The system of claim 10, wherein upon selecting a media file from within the set of search results, the website will display the theme, or multiple themes, which were assigned to the selected media file.
